(19) United States
(12) Patent Application Publication
(10) Pub. No.: US 2021/0035119 A1
(43) Pub. Date: Feb. 4, 2021

(54) METHOD AND SYSTEM FOR REAL-TIME AUTOMATED IDENTIFICATION OF FRAUDULENT INVOICES

(71) Applicant: Intuit Inc., Mountain View, CA (US)

(72) Inventors: Liron Hayman, Tel Aviv (IL); Yair Horesh, Kfar-Saba (IL); Yehezkel S. Resheff, Tel Aviv (IL)

(73) Assignee: Intuit Inc., Mountain View, CA (US)

(21) Appl. No.: 16/525,228

(22) Filed: Jul. 29, 2019

(51) Int. Cl. G06Q 30/00; G06F 17/27; G06Q 30/04

(52) U.S. Cl. CPC G06Q 30/0185; G06Q 30/04; G06F 17/27

(57) ABSTRACT

Known fraudulent invoice data, including defined and known fraudulent invoice feature data, is used to train a machine learning-based fraudulent invoice detection model to generate a fraudulent invoice score for invoices indicating a determined probability that a given invoice is fraudulent. The machine learning-based fraudulent invoice detection model is then used to generate a fraudulent invoice score for subsequent invoices before those invoices are paid by, and in some cases before the invoices are provided to, the parties being asked to pay the invoices. The fraudulent invoice score for the subsequent invoice is then used to determine if the subsequent invoice should be passed on to the parties being asked to pay the invoices for payment, or if one or more protective actions should be taken.

### BACKGROUND

Data management systems, such as transaction data management systems, personal financial management systems, small business management systems, tax preparation systems, and the like, have proven to be valuable and popular tools for helping users of these systems perform various tasks and manage their personal and professional lives.

One important feature offered through some data management systems is electronic payment and transaction processing. In particular, some data management systems offer merchant/payee users of the data management system the capability to generate and/or submit invoices through the data management system. Some data management systems also provide customer/payor users the capability to pay invoices through the data management system. Of course, as with any billing and payment system, data management systems that provide the capability to submit and pay invoices are more susceptible to fraudulent activity. Consequently, providers of these data management systems must implement fraud detection and prevention systems and then continually adapt these fraud detection and prevention systems to the ever-evolving methods and tactics used to perpetuate fraud.

As a specific illustrative example of fraudulent activity, some perpetuators of fraudulent activity (herein referred to as “fraudsters”) generate and distribute fake, or fraudulent, invoices to potential victims. Typically, these fraudulent invoices appear to be from merchants that the fraudster has either determined the victims know and use, or that the victims are likely to know and use based on the popularity of the merchants' products or services.

In some cases, fraudsters can distribute these fraudulent invoices through a data management system, or other payment and transaction processing system, by opening an account with the data management system and generating the invoices directly through the data management system. In other cases, fraudulent invoices can be distributed by generating the fraudulent invoices outside the data management system, and then uploading the invoices to the data management system. In addition, these fraudulent invoices can be distributed through e-mail, postal service, or even SMS/text messaging. In these cases, the victim/user of the data management system, may upload the fraudulent invoice themselves for payment through the data management system, or otherwise bring the invoice into the data management system for payment.

Once the fraudulent invoice is provided to the potential victim, the potential victim is typically requested to pay the invoice using a credit card, or debit card, or other type of electronic payment account. If the potential victim simply pays the invoice by providing their electronic payment account information, then the fraudster obtains the electronic payment account information and uses it to make unauthorized purchases; at this point the potential victim becomes an actual victim.

In other cases, the fraudsters first obtain a victim's electronic payment account information. Then in an effort to by-pass traditional fraud detection systems, the fraudster generates a fraudulent invoice through an alias account created by the fraudster in the data management system. Then, the fraudster sends the invoice to themselves, or another alias of themselves, and pays the invoice using the victim's stolen electronic payment account information. In short, the fraudster creates a fake merchant account in a data management system, generates a fraudulent invoice through this fake merchant account, sends the fraudulent invoice to another account created by the fraudster, and then uses the victim's stolen electronic payment account information to pay themselves.

The above are but two examples of the many ways fraudsters attempt to use fraudulent invoices to perpetrate fraud through a data management system. Unfortunately, these methods can be quite effective because using traditional fraud detection systems most victims only become aware of the fraudulent invoices and transactions after the invoice has been paid and they receive a bill from their credit card, debit card, or other electronic payment account provider. This retroactive approach to fraud detection typically results in the fraudster having essentially successfully perpetrated the fraud by the time the fraud is detected. In addition, these traditional retroactive approaches to fraud detection typically result in the victim, the data management system provider, and the credit card, debit card, or other electronic payment account provider, all expending significant time and energy dealing with the ramifications of the fraud, and, hopefully, correcting the issue. Since these costs are often passed on to all users of credit cards, debit cards, or other electronic payment accounts, this situation is a problem for virtually all users of credit cards, debit cards, or other electronic payment accounts.

As noted, traditional fraud detection systems only detect fraudulent invoices after the invoices have been paid and the victim questions a resulting credit card, debit card, or other electronic payment account bill, i.e., the detection of the fraudulent invoice is retroactive/reactive. It is this retroactive/reactive approach to fraudulent invoice detection that results in the successful perpetration of the fraud and causes all the parties involved to expend so much time, energy, and expense dealing with the ramifications of the fraud. Clearly a proactive fraud detection approach that could detect the fraudulent invoices before they are paid would be a better solution. However, traditional proactive methods to detect fraud, and fraudulent invoices in particular, have proven either ineffective or prohibitively inefficient and expensive.

As an extreme example, if every invoice and payment were individually analyzed by human analysts before the invoice was processed, or payment was sent, it is highly likely that the vast majority of attempted fraudulent invoice transactions would be accurately detected and stopped. However, the delays caused by this process would be unacceptable to all parties involved, not to mention that any such process would be prohibitively expensive.

To avoid this result, some traditional systems try to automate the fraud detection process. However, these systems are typically too static and limited in scope to keep up with the ever-changing tactics used by fraudsters. This often results in many misidentifications of fraud, or missed incidents of fraud, i.e., false positive and negative results. As a result, these traditional approaches are not only ineffective, but also create a false sense of security and complacency that can be even more problematic than simply not having these systems in place at all. This issue is particularly pronounced when the fraud takes the form of fraudulent invoices. This is because of the amount of data typically presented in an invoice, the number of variations in legitimate invoices, and the resulting number of opportunities for fraudsters to generate fraudulent invoices that will avoid detection by currently available fraud detection methods and systems.

Consequently, there is a long-standing technical issue associated with virtually every type of electronic invoice and transaction processing system, including data management systems, of how to accurately identify, and prevent, fraudulent invoice related transactions without placing undue processing and delay burdens on legitimate users of these systems. What is needed is a technical solution to this long-standing technical problem that is capable of automatically, accurately, effectively, and efficiently detecting fraudulent invoices before those invoices are paid, and preferably before the fraudulent invoices are provided to potential victims.

### SUMMARY

The systems and methods of the present disclosure provide a technical solution to the technical problem of automatically, accurately, effectively, and efficiently detecting fraudulent invoices before those invoices are paid. This is accomplished in part by using machine learning techniques to generate fraud scores for invoices and then initiate protective action when needed before the invoices are paid by, or in some cases before they are presented to, the parties being asked to pay the invoices.

To this end, the systems and methods of the present disclosure obtain historical invoice data representing historical invoices, and potentially including historical invoice data associated with both fraudulent and legitimate invoices. In addition, fraudulent merchant data is obtained representing a listing of known fraudulent merchants from one or more sources.

Invoice features are then identified or defined whose associated invoice feature data can is determined to be indicative of either fraudulent or legitimate invoices.

Once the invoice features are defined, the historical invoice data is processed to identify invoice text data in the invoices. The identified invoice text data is then further processed to extract invoice feature data associated with the each of the defined invoice features from each invoice represented in the historical invoice data.

As noted, the historical invoice data potentially includes invoice data associated with both fraudulent and legitimate invoices. Consequently, the extracted invoice feature data is also potentially associated with both fraudulent and legitimate invoices. Therefore, once the feature data is extracted from each invoice represented in the historical invoice data, the known fraudulent merchant data is used to identify extracted invoice feature data that is associated with fraudulent invoices.

Once fraudulent invoice feature data is identified, this data can be used as training data for a machine learning-based fraudulent invoice detection model. The machine learning-based fraudulent invoice detection model can be trained using the fraudulent invoice feature data to generate fraudulent invoice scores for invoices indicating a determined probability that a given invoice is fraudulent.

Once the machine learning-based fraudulent invoice detection model is trained, it is deployed in a runtime environment to generate fraudulent invoice scores for subsequent, or new, invoices before those invoices are paid by, and in some cases before the invoices are provided to, the parties being asked to pay the invoices, i.e., the potential payors associated with the invoices. Once a fraudulent invoice score for a subsequent invoice is generated, the fraudulent invoice score for the subsequent invoice is compared with one or more threshold fraudulent invoice scores. The one or more threshold fraudulent invoice scores can be associated with one or more respective protective actions to be taken.

For instance, if the fraudulent invoice score for a subsequent invoice is less than a first, or low, threshold fraudulent invoice score, the subsequent invoice is passed through to the indicated payor, or the payor is allowed to pay the invoice, without further analysis. However, if the fraudulent invoice score for a subsequent invoice is greater than a second, or high, threshold fraudulent invoice score, one or more of the following protective actions are taken: the merchant associated subsequent invoice is added to the known fraudulent merchant list of the fraudulent merchant data; the subsequent invoice is blocked, or the payor is not allowed to pay the invoice; all future invoices from the now identified fraudulent merchant are blocked; and all future attempted payments to the now identified fraudulent merchant are blocked.

In some cases, the fraudulent invoice score for a subsequent invoice is between the first, or low, threshold fraudulent invoice score and the second, or high, threshold fraudulent invoice score. In these cases, an alert can be generated and provided to a fraudulent invoice analyst and/or the indicated payor indicating that the analyst and/or payor should make sure that the invoice is legitimate before making or allowing any payment associated with the invoice.

The machine learning-based fraudulent invoice detection model is provided with an updated list of fraudulent merchants in the fraudulent merchant data and/or newly defined identified invoice features periodically and is iteratively updated and improved by periodic re-training. Consequently, the fraudulent invoice identification methods and systems disclosed herein can dynamically react to new techniques used by fraudsters and new fraudulent invoice data.

These and other features of the disclosed embodiments discussed in more detail below provide a technical solution to the long-standing technical problem of automatically, accurately, effectively, and efficiently detecting fraudulent invoices before those invoices are paid. In addition, as discussed in more detail below, by using machine learning processes to dynamically update the fraudulent invoice detection model, the disclosed embodiments can dynamically and rapidly adapt to the everchanging techniques used by fraudsters in attempts to avoid detection.

Consequently, the systems and methods of the present disclosure provide a highly flexible technical solution to the problem of proactively and accurately detecting fraudulent invoices without placing a processing or delay burden on either the data management system/electronic payment system implementing the disclosed embodiments or the users of these systems.

### BRIEF DESCRIPTION OF THE DRAWINGS

FIG. 1 is a high-level block diagram of a model training environment for training a machine learning-based fraudulent invoice detection model for use with a method and system for real-time automated identification of fraudulent invoices in accordance with one embodiment.

FIG. 2 is an illustrative example of an invoice feature list in accordance with one embodiment.

FIG. 3 is an illustrative example of a fraudulent invoice and fraudulent invoice features in accordance with one embodiment.

FIG. 4 is an illustrative example of a machine learning-based fraudulent invoice detection model training data matrix in accordance with one embodiment.

FIG. 5 is a high-level block diagram of a runtime environment for implementing a method and system for real-time automated identification of fraudulent invoices in accordance with one embodiment.

FIG. 6 is a flow chart representing a process for training a machine learning-based fraudulent invoice detection model in accordance with one embodiment.

FIG. 7 is a flow chart representing a process for real-time automated identification of fraudulent invoices in accordance with one embodiment.

Common reference numerals are used throughout the FIGs. and the detailed description to indicate like elements. One skilled in the art will readily recognize that the above FIGs. are merely illustrative examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGs. which depict one or more exemplary embodiments. Embodiments may be implemented in many different forms and should not be construed as limited to the embodiments set forth herein, shown in the FIGs., and/or described below. Rather, these exemplary embodiments are provided to allow a complete disclosure that conveys the principles of the invention, as set forth in the claims, to those of skill in the art.

The systems and methods of the present disclosure use known fake, or fraudulent, invoices to determine applicable parts, or features, of both fraudulent and legitimate invoices that can be checked to identify fraudulent invoices. Once these invoice features are determined, the invoice features of known fraudulent invoices are used to teach a machine learning-based model how to predict if an invoice is a fraudulent invoice.

Once this fraudulent invoice detection model is trained to predict if an invoice is a fraudulent invoice, it is used to process subsequently submitted, or new, invoices, to predict how likely it is the new invoices are fraudulent before those invoices are paid by the person to whom the invoice is being sent.

If the fraudulent invoice detection model predicts a new invoice is not very likely to be fraudulent, the new invoice is passed along to the person being asked to pay the invoice and the person is allowed to pay the invoice without further analysis. However, if the fraudulent invoice detection model predicts a new invoice is very likely to be fraudulent, the new invoice is blocked, and the person is not allowed to pay the invoice, at least without further analysis. If the fraudulent invoice detection model predicts a new invoice is neither very likely or unlikely to be fraudulent, then the person being asked to pay the invoice can be alerted to the potentially fraudulent nature of the new invoice and advised to make sure that the new invoice is legitimate before making any payment associated with the invoice.

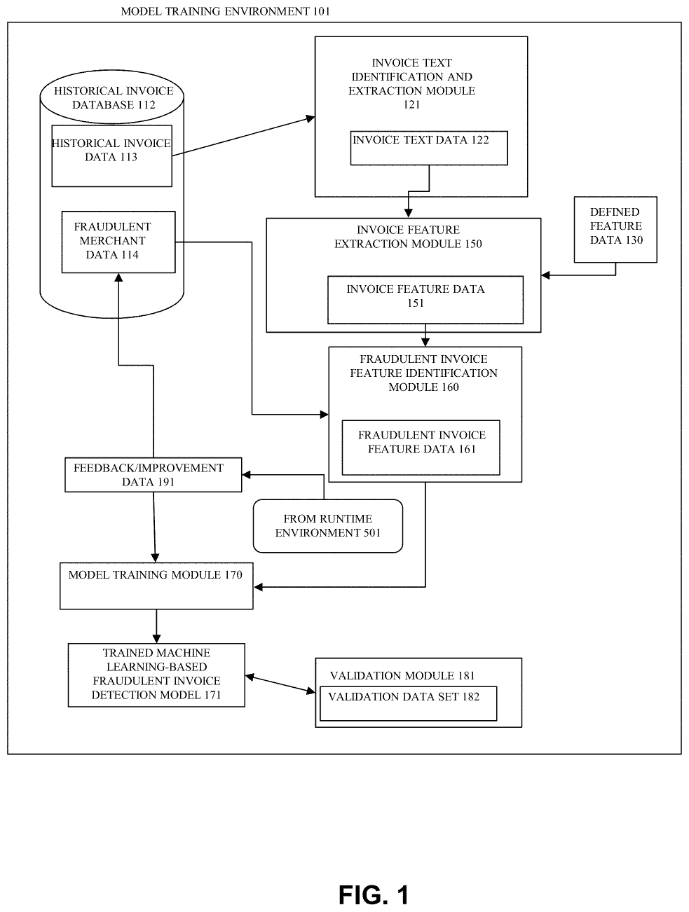

FIG. 1 is a high-level block diagram of a model training environment 101 for training a machine learning-based fraudulent invoice detection model for use with a method and system for real-time automated identification of fraudulent invoices.

As seen in FIG. 1, model training environment 101 includes historical invoice database 112, invoice text identification and extraction module 121, invoice feature extraction module 150, fraudulent invoice feature identification module 160, model training module 170, trained machine learning-based fraudulent invoice detection model 171, and validation module 181.

As seen in FIG. 1, historical invoice database 112 includes historical invoice data 113 representing historical invoices. Historical invoice data 113 typically includes data representing numerous individual invoices, potentially including both fraudulent and legitimate invoices. Historical invoice data 113 can be obtained from multiple sources including, but not limited to, one or more data management systems associated with model training environment 101. As noted above, many data management systems, including, but not limited to, small business data management systems, personal financial data management systems, transaction data management systems, and the like, offer various billing and bill payment capabilities to the users of these data management systems. In particular, some data management systems offer merchant/payee users of the data management system the capability to generate and/or submit invoices through the data management system, and customer/payor users the capability to pay invoices through the data management system. Consequently, in one example, historical invoice data 113 is obtained by collecting various invoices submitted to the data management systems by merchant users of the data management systems.

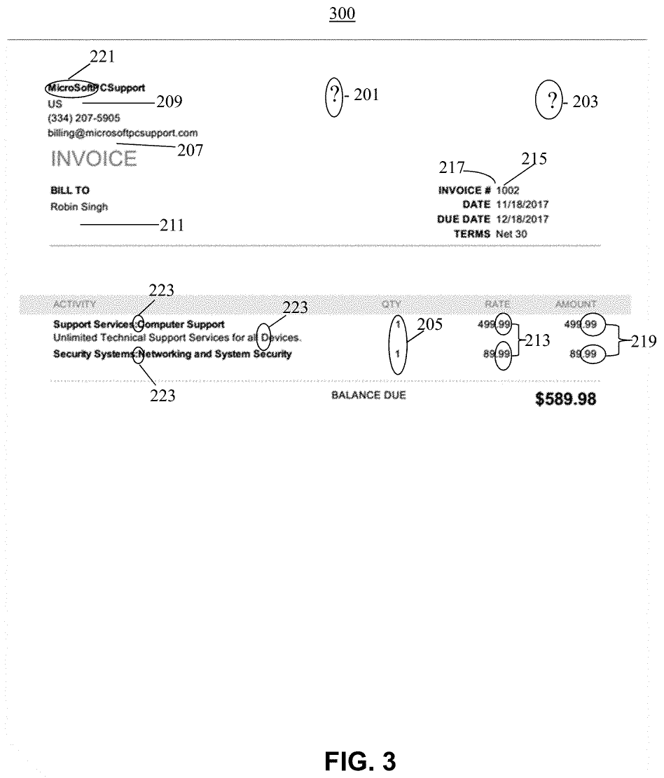

As will be discussed in more detail below, FIG. 3 as an example of an invoice, in the particular example of FIG. 3 a fraudulent invoice, that is illustrative of the types of invoices represented by historical invoice data 113.

In some cases, the historical invoices represented by historical invoice data 113 are generated outside of the data management system and are either submitted by a merchant user of the data management system or are uploaded by customer or payor user of the data management system.

In some cases, the historical invoices represented by historical invoice data 113 are obtained from data processed and generated by machine learning-based fraudulent invoice detection models, such as trained machine learning-based fraudulent invoice detection model 171.

In some cases, the historical invoices represent by historical invoice data 113 come from any or all sources of historical invoice data 113 discussed herein or known in the art at the time of filing, or as become known after the time of filing.

As seen in FIG. 1, historical invoice database 112 also includes fraudulent merchant data 114. Fraudulent merchant data 114 can include a listing of known fraudulent merchants. Fraudulent merchant data 114 can be obtained from multiple sources including, but not limited to, the results of analysis of historical invoices determined to be fraudulent by human fraud detection analysts. In these cases, fraudulent merchant data 114 is obtained as a result of analysis of historical invoices that were determined to be fraudulent, typically after charges associated with these invoices were challenged by the owners of the payment accounts used to pay the fraudulent voices. In other cases, fraudulent merchant data 114 can be obtained from third parties, including various watchdog organizations or other third-party sources of fraudulent merchant data 114 indicating known fraudulent merchants, as discussed herein, or known in the art at the time of filing, or as become known after the time of filing. In other cases, fraudulent merchant data 114 can be obtained from data processed and generated by machine learning-based fraudulent invoice detection models, such as trained machine learning-based fraudulent invoice detection model 171.

In some cases, particularly those cases where fraudulent merchant data 114 is obtained from third-party sources, the actual invoices submitted by the fraudulent merchants are not obtained. In these cases, only the fraudulent merchant data 114 indicating the merchants involved is known. However, as noted above, historical invoice data 113 typically includes significant amounts of historical invoice data representing a significant number of invoices. Therefore, historical invoice data 113 typically includes both historical invoice data representing legitimate invoices and historical data representing any fraudulent invoices. In addition, as discussed in more detail below, the invoices represented in historical invoice data 113, including potential fraudulent invoices, is processed and the merchants associated with the invoices represented in historical invoice data 113 are identified. Consequently, as discussed in more detail below, the merchants associated with each of the invoices represented in historical invoice data 113 can be identified and compared with a list of fraudulent merchants represented in fraudulent merchant data 114. This process is discussed in more detail below with respect to invoice text identification and extraction module 121 and invoice feature extraction module 150.

As seen in FIG. 1, historical invoice data 113 is provided to invoice text identification and extraction module 121. At invoice text identification and extraction module 121 one or more methods are used to identify and extract invoice text data 122 associated with each of the invoices included in historical invoice data 113. In one example, Optical Character Recognition (OCR) techniques are used to identify and extract the invoice text data 122 associated with each of the invoices included in the historical invoice data 113. Various OCR systems and techniques are well known to those of skill in the art. Consequently, a more detailed description of the operation of any specific OCR technique used to identify and extract invoice text data 122 associated with each of the invoices included in historical invoice data 113 is omitted here to avoid detracting from the invention.

Once invoice text data 122 associated to each of the invoices included in historical invoice data 113 is identified and extracted, the invoice text data 122 associated with each of the invoices included in historical invoice data 113 is provided to invoice feature extraction module 150. At invoice feature extraction module 150, the invoice text data 122 is further processed to identify and extract one or more features associated with each of the invoices included in historical invoice data 113.

The invoice features can be pre-defined, or pre-identified, as features, or data elements, associated with invoices that, depending on the present, absence, or state, of the features can be indicative of fraud or legitimacy of a given invoice. In some cases, the invoice features are defined by analysis of historically known fraudulent invoices and the elements of those invoices that were found to be indicative, or not indicative, of fraudulent invoices. In some cases, the invoice features are defined by analysis performed by human analysts. In other cases, the invoice features are defined and identified by virtue of the processing of historical invoice data 113 by one or more processing modules including, but not limited to one or more machine learning-based models. In some cases, the invoice features are defined and identified by machine learning-based fraudulent invoice detection models, such as trained machine learning-based fraudulent invoice detection model 171.

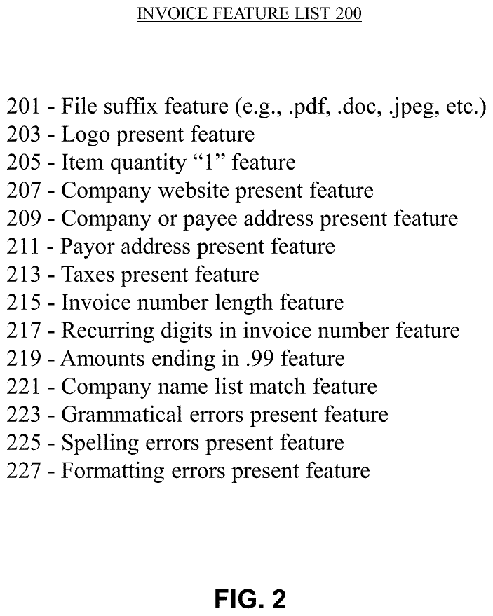

Once defined, data representing the invoice features is collected as defined feature data 130. FIG. 2 is an illustrative example of an invoice feature list 200 that could be included in defined feature data 130 of FIG. 1. It must be noted that the invoice feature list 200 of FIG. 2 includes a mere sampling of the number and type of invoice features that can be defined, identified, and extracted according to the disclosed embodiments. In particular, the number and type of invoice features shown in invoice feature list 200 is by no means exhaustive nor limiting with respect to the number and type of invoice features contemplated by the inventors.

Referring to FIG. 2, invoice feature list 200, in this specific illustrative example, includes file suffix feature 201. File suffix feature 201 is a feature indicating a format type, or document type, associated with a given invoice. As specific illustrative examples, a given invoice could be submitted as a PDF document, a Word document, a JPEG document, etc. In some cases, the type of documents submitted can be indicative of either a legitimate or fraudulent invoice. For instance, it could be determined that the majority of fraudulent invoices submitted are of a PDF document type. Consequently, if file suffix feature 201 indicates a PDF format this could be indicative of a potentially fraudulent invoice. File suffix feature 201 is typically a category type feature.

Invoice feature list 200, in this specific illustrative example, also includes logo present feature 203. Logo present feature 203 is a Boolean feature indicating either the presence or absence of a merchant or company logo in a given invoice. Logo present feature 203 can be indicative of either a legitimate or fraudulent invoice. In particular, many fraudulent invoices do not include a logo associated with the merchant or company supposedly generating the invoice. Consequently, the absence of a logo, or a “false” invoice feature data entry or state for logo present feature 203 can be indicative of a fraudulent invoice.

Invoice feature list 200, in this specific illustrative example, also includes item quantity feature 205. Item quantity feature 205 is a feature indicating whether the quantities of items purportedly being charged for in an invoice are realistic and variable, as would be true for most cases of a legitimate invoice. In particular, item quantity feature 205 can be a Boolean feature directed to determining if the quantities of items listed in invoice are all equal to one, e.g. the number “1”. If all the quantities of items listed invoice are equal to one, it is more likely that the invoice in question including these quantities is fraudulent because it has been determined that many fraudulent invoices include only quantities of “1” while legitimate invoices often include other quantities such as 2, 5, 100, etc. Consequently, a “true” invoice feature data entry or state for item quantity feature 205 can be indicative of a fraudulent invoice.

Invoice feature list 200, in this specific illustrative example, also includes company website present feature 207. Company website present feature 207 is a Boolean feature that is directed to determining if a company website is included in a given invoice. Company website present feature 207 is included as an invoice feature because it is often the case that fraudulent invoices do not include a company website listing. Consequently, absence of a company website, i.e., a “false” invoice feature data entry or state for company website present feature 207 can be indicative of a fraudulent invoice.

Invoice feature list 200, in this specific illustrative example, also includes company or payee address present feature 209. Company or payee address present feature 209 is a Boolean feature directed to determining if an address is included in the invoice that is associated with the company or merchant purportedly generating the invoice. Company or payee address present feature 209 is included as an invoice feature because it is often the case that fraudulent invoices do not include a company or payee address. Consequently, the absence of a company or payee address i.e., a “false” invoice feature data entry or state for company or payee address present feature 209, can be indicative of a fraudulent invoice.

Invoice feature list 200, in this specific illustrative example, also includes payor address present feature 211. Payor address present feature 211 is a Boolean feature directed to determining whether a given invoice includes an address for the party being presented with the invoice, i.e. the potential payor of the invoice. Payor address present feature 211 is included as an invoice feature because it is often the case that fraudulent invoices do not include a payor address. Consequently, the absence of a payor address i.e., a “false” invoice feature data entry or state for payor address present feature 211 can be indicative of a fraudulent invoice.

Invoice feature list 200, in this specific illustrative example, also includes taxes present feature 213. Taxes present feature 213 is a Boolean feature indicative of the presence or absence of local, state, or federal taxes in the amounts due calculations presented in a given invoice. It has been determined that the absence of taxes being charged associated with the services and products represented in an invoice is indicative of a potentially fraudulent invoice. Consequently, the absence of any tax charges associated with a given invoice, i.e., a “false” invoice feature data entry or state for taxes present feature 213 can be indicative of a potentially fraudulent invoice.

Invoice feature list 200, in this specific illustrative example, also includes invoice number length feature 215. Invoice number length feature 215 is used to indicate whether the invoice number length associated with the given invoice is realistic for not only the given invoice but, in some cases, for the company name, or merchant, associated with the invoice. As an example, an invoice with the invoice number 001 is more likely to be a fraudulent invoice then an invoice with a larger and more complicated invoice number. In addition, it is expected that invoices purportedly being generated by well-known and large companies would have larger, or more regularly formatted, invoice numbers. Consequently, if these invoices have small numbers this is considered indicative of a potential fraudulent invoice.

Invoice feature list 200, in this specific illustrative example, also includes recurring digits in invoice number feature 217. Recurring digits in invoice number feature 217 is used indicate whether the invoice number associated with the given invoice is realistic in terms of the variance of the characters indicated in the invoice. Continuing with the example above, an invoice number 001, or any invoice including repeated digits, has been determined to be indicative of a potential fraudulent invoice.

Invoice feature list 200, in this specific illustrative example, also includes amounts ending in .99 feature 219. Amounts ending in .99 feature 219 is used to indicate if all, or a large percentage, of the amounts listed in a given invoice end in .99, or 99 cents. It has been determined that when many, or all, of the amounts listed in invoice end in .99, or 99 cents, this can be indicative of a potentially fraudulent invoice. Consequently, if all or many amounts end in .99, i.e., a “true” invoice feature data entry or state for amounts ending in .99 feature 219 this can be indicative of a potentially fraudulent invoice.

Invoice feature list 200, in this specific illustrative example, also includes company name list match feature 221. Company name list match feature 221 is a Boolean feature that indicates if the company name associated with the invoice is included in a list of company names commonly used by fraudsters as the merchant purportedly issuing the invoice. The company names in the company list are typically those that fraudsters have historically used based on the fact that these companies provide services to a large segment of the population. Examples of companies that might be included in a company list might be Microsoft or Amazon. Consequently, when companies included in the company list are present in an invoice, i.e., a “true” invoice feature data entry or state for company name list match feature 221 this may be indicative of the potentially fraudulent invoice.

Invoice feature list 200, in this specific illustrative example, also includes grammatical error present feature 223. Grammatical errors present feature is a Boolean feature indicative of the presence or absence of grammatical errors in the text and other portions of given invoice. Generally speaking, grammatical errors are far more prevalent in fraudulent invoices then in legitimate invoices. Consequently, an invoice feature data entry or state of “true” for grammatical errors present feature 223 can be indicative of a potentially fraudulent invoice. In some cases, grammatical errors present feature 223 is determined based on processing of the invoice text data 122 of FIG. 1 using one or more Natural Language Processing (NLP) techniques. NLP techniques are well known to those of skill in the art and therefore a more detailed discussion of the use of any particular NLP techniques used to identify grammatical errors is omitted here to avoid detracting from the invention.

Invoice feature list 200, in this specific illustrative example, also includes spelling errors present feature 225. Spelling errors present feature 225 is a Boolean feature indicative of the presence or absence of spelling errors in the text and other portions of the given invoice. Generally speaking, spelling errors are far more prevalent in fraudulent invoices then in legitimate invoices. Consequently, an invoice feature data entry or state of “true” for spelling errors present feature 225 can be indicative of a potentially fraudulent invoice. In some cases, spelling errors present feature 225 is determined based on processing of the invoice text data 122 of FIG. 1 using one or more Natural Language Processing (NLP) techniques. NLP techniques are well known to those of skill in the art and therefore a more detailed discussion of the use of any particular NLP techniques used to identify spelling errors is omitted here to avoid detracting from the invention.

Invoice feature list 200, in this specific illustrative example, also includes formatting errors present feature 227. Formatting errors present feature 227 is a Boolean feature indicative of the presence or absence of spelling errors in the text and other portions of the given invoice. Generally speaking, formatting errors are far more prevalent in fraudulent invoices then in legitimate invoices. Consequently, an invoice feature data entry or state of “true” for formatting errors present feature 227 can be indicative of a potentially fraudulent invoice.

Once again, it must be stressed that the invoice feature list 200 of FIG. 2 includes a mere sampling of the number and type of invoice features that can be defined, identified, and extracted according to the disclosed embodiments. In particular, the number and type of invoice features shown in invoice feature list 200 is by no means exhaustive nor limiting with respect to the number and type of invoice features contemplated by the inventors.

FIG. 3 is an illustrative example of invoice that might be included in historical invoice data 113. In this specific illustrative example, a fraudulent invoice 300, including various invoice features that can be indicative of fraud is illustrated. Referring to FIGS. 1, 2, and 3, together, invoice 300 includes company or payee name data “MicrosoftPCsupport.” In this specific illustrative example this company name is subject to two invoice features of interest: company name list match feature 221, which is a “true” state invoice feature data value for invoice 300 because the company “MicroSoft”is included in a company name list indicative of a potential fraudulent invoice; and grammatical errors present feature 223, which is also a “true” state invoice feature value for invoice 300 because the listed company name “MicroSoftPCsupport” does not include any spacing between the terms Microsoft, PC, and support, and has a capitalized “S” in Microsoft.

Invoice 300 also includes a partial company address of “US” and therefore is subject to a company or payee address present feature 209 data value of “false” because the company address is not a complete mailing address or a physical location. Likewise, invoice 300 is subject to a company website present feature 207 data value of “false” because no company website is present in invoice 300. Likewise, invoice 300 does not include an address for the listed “bill to” payor “Robin Singh” so a payor address present feature 211 data value of “false” is given.

Invoice 300 is also subject to a “false” invoice feature data value for logo present feature 203 in that no company logo is present in invoice 300. In addition, invoice 300 has an invoice number that is of unexpectedly short length for a Microsoft invoice and has repeated digits. Consequently, invoice 300 is subject to a potentially fraudulent invoice status using invoice number length feature 215 and recurring digits in invoice number feature 217.

Invoice 300 also includes at least two additional spelling errors, and a “true” invoice feature data value for grammatical errors present feature 223, including the lack of a space between the term “Support Services:” and the term “Customer Support” and a similar graphical error present in the term “Security Systems:Networking and System Security.” In addition, invoice 300 includes capitalization and formatting errors for the term “Unlimited Technical Support Services for all Devices” which would result in an invoice feature data value of “true” for formatting errors present feature 227.

In addition, all the rates and amounts listed in invoice 300 end in .99. Consequently, invoice 300 is subject to an invoice feature data value of “true” for amounts ending in .99 feature 219. Likewise, all the quantities listed in invoice 300 are “1.” Therefore, invoice 300 is subject to an invoice feature data value of “true” for item quantity feature 205.

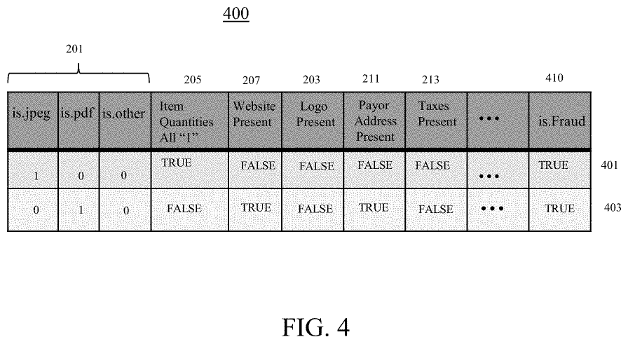

As discussed in more detail below, FIG. 4 is an illustrative example of a machine learning-based fraudulent invoice detection model training data matrix 400 in accordance with one embodiment. Referring to FIGS. 2, 3, and 4 together, line 401 in fraudulent invoice detection model training data matrix 400 is representative of invoice 300 and the feature results discussed above with respect to FIG. 3. As can be seen in FIG. 4, line 401 indicates that invoice 300 is in a JPEG format, has an invoice feature data entry of “true” for item quantities all “1” invoice feature 205, has an invoice feature data entry of “false” for company website present feature 207, has an invoice feature data entry of “false” for logo present feature 203, has an invoice feature data entry of “false” for payor address present feature 211, has an invoice feature data entry of “false” for taxes present feature 213, and has an entry of “true” for is_fraud label 410. As discussed in more detail below, feature data for multiple invoices arranged as in fraudulent invoice detection model training matrix 400 is used as training data by model training module 170 to train trained machine learning-based fraudulent invoice detection model 171 of FIG. 1.

Returning to FIG. 1, in order for invoice feature extraction module 150 to identify the features present in a given invoice of historical invoice data 113 it is important that invoice text data 122 be processed by one or more methods to indicate not only that the invoice feature is present, but also the location of the invoice feature data in the invoice data. In one example, this is accomplished by using a combination of OCR techniques discussed above and JavaScript Object Notation (JSON).

JSON is an open-standard file format that uses human readable text to transmit data objects consisting of attribute-value pairs and array datatypes. Importantly, when text is converted into JSON file format each object in the text is described as an object at a very precise location in the text document. Consequently, when text data, such as invoice text data 122, is converted into JSON file format, the name of the potential invoice feature is indicated as the object and the precise location of the object and data associated with that object in the vicinity of the object is indicated. Consequently, by converting invoice text data 122 into a JSON file format the identification of the invoice features and invoice feature data within the invoice text data is a relatively trivial task. JSON is well known top those of skill in the art, therefore a more detailed discussion of JSON, and JSON file formatting, is omitted here to avoid detracting from the invention.

Once the invoice features are identified and extracted as invoice feature data for each invoice represented in historical invoice data 113, the invoice feature data for all of the invoices represented in historical invoice data 113 is collected as invoice feature data 151, including data indicating the features associated with the invoices and correlating the features of the invoices with the invoices themselves and, importantly, the merchants associated with the invoices, i.e., the merchants having submitted the invoices.

As noted, the historical invoice data 113 potentially includes invoice data associated with both fraudulent and legitimate invoices. Consequently, the extracted invoice feature data 151 is also potentially associated with both fraudulent and legitimate invoices. Therefore, once the invoice feature data 151 is extracted from each invoice represented in the historical invoice data 113, the known fraudulent merchant data 114 can be used to identify extracted invoice feature data that is associated with fraudulent invoices.

As seen in FIG. 1, once invoice feature data 151 is generated, invoice feature data 151 is provided to fraudulent invoice feature identification module 160. At fraudulent invoice feature identification module 160 the invoice feature data 151, and in particular data indicating the merchant associated with each of the invoices used to generate invoice feature data 151, is compared, or joined, with fraudulent merchant data 114 to identify fraudulent invoice feature data included in invoice feature data 151.

The fraudulent invoice feature data for each identified fraudulent invoice included in historical invoice data 113 is collected as fraudulent invoice feature data 161. Fraudulent invoice feature data 161 is then provided to model training module 170 where it is used as training data to generate trained machine learning-based fraudulent invoice detection model 171. As discussed below, trained machine learning-based fraudulent invoice detection model 171 is then used to generate fraudulent invoice scores for subsequent invoices indicating a determined probability that a given subsequent invoice is fraudulent.

As noted above, fraudulent invoice feature data 161 is organized in a table or matrix, such as machine learning-based fraudulent invoice detection model training data matrix 400 of FIG. 4. Referring to FIGS. 2, 3, and 4, the fraudulent feature data associated with each identified fraudulent invoice in historical invoice data 113 is arranged in a row, such as row 401 representing the fraudulent feature data which, as discussed above, is associated with invoice 300 of FIG. 3.

As seen in FIG. 4, each defined feature of defined feature data 130, such as the illustrative invoice features of invoice feature list 200 of FIG. 2, is listed as a column heading of machine learning-based fraudulent invoice detection model training data matrix 400. The invoice feature data values for each listed invoice feature column headings are entered in their respective columns to create rows of invoice feature data for each fraudulent invoice. In FIG. 4, these are rows 401 and 403, with row 401 representing invoice 300 and row 403 representing another invoice. Also included in each row of machine learning-based fraudulent invoice detection model training data matrix 400 is label column 410 indicating if the invoice associated with the row of invoice feature data has been determined fraudulent.

The data included in machine learning-based fraudulent invoice detection model training data matrix 400 can be used to train a supervised machine learning-based fraudulent invoice detection model. In this case, the rows of feature data represent invoice feature vector data associated with each fraudulent invoice and are used as input objects by model training module 170 to train a machine learning-based fraudulent invoice detection model. In these supervised learning examples, the data entries in label column 410 are used as supervisory signals, or labels.

Those of skill in the art will recognize that while only two rows are shown in FIG. 4 for illustrative purposes, in practice machine learning-based fraudulent invoice detection model training data matrix 400 may include, hundreds, thousands, or millions of rows representing hundreds, thousands, or millions of known fraudulent invoices and that more rows can be added to machine learning-based fraudulent invoice detection model training data matrix 400, representing more fraudulent invoices as those fraudulent invoices are identified.

Returning to FIG. 1, once fraudulent invoice feature data 161 is provided to model training module 170 and used to generate trained machine learning-based fraudulent invoice detection model 171, trained machine learning-based fraudulent invoice detection model 171 is validated using validation module 181. Validation module 181 is used to provide a validation data set 182 to trained machine learning-based fraudulent invoice detection model 171.

Validation data set 182 includes invoice data representing both legitimate and fraudulent invoices. The validation data set 182 is then processed by trained machine learning-based fraudulent invoice detection model 171 to generate fraudulent invoice scores for the invoices represented in validation data set 182. Any invoices in validation set data 182 determined to be fraudulent by trained machine learning-based fraudulent invoice detection model 171 are then sent to human analysts for confirmation. In this way, trained machine learning-based fraudulent invoice detection model 171 can be tested, calibrated, re-trained, and improved.

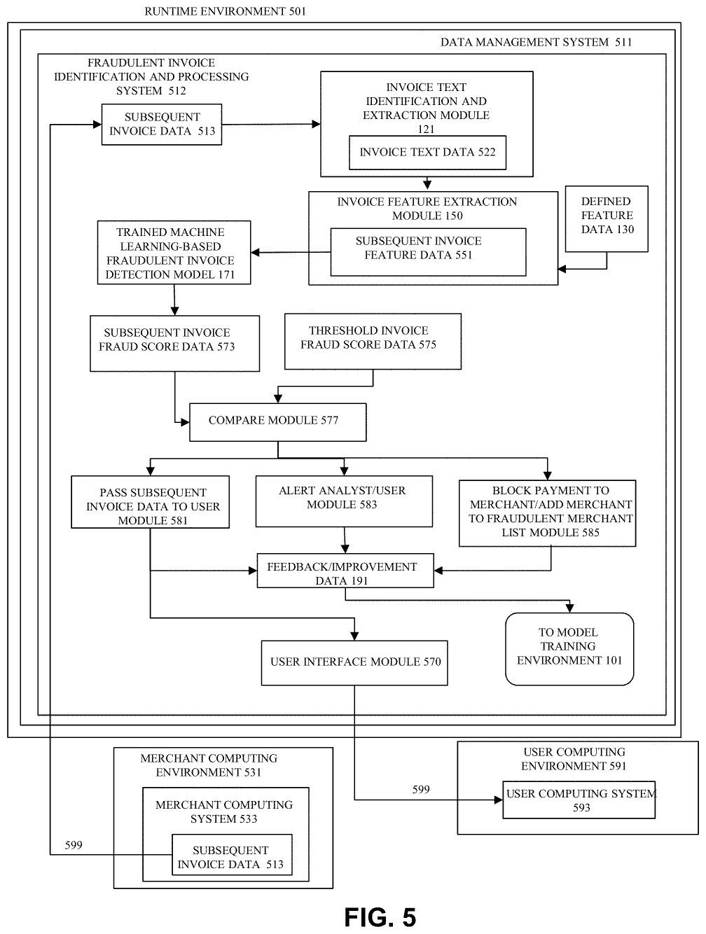

As discussed in more detail below, once trained machine learning-based fraudulent invoice detection model 171 is generated and validated, trained machine learning-based fraudulent invoice detection model 171 is deployed in runtime environment 501 of FIG. 5. As also discussed in more detail below, based on the operation and data collected by trained machine learning-based fraudulent invoice detection model 171 in runtime environment 501, feedback/improvement data 191 may be generated. As discussed below, feedback/improvement data 191 is then used in model training environment 101 to update fraudulent merchant data 114 and re-train, improve and update trained machine learning-based fraudulent invoice detection model 171 via model training module 170.

FIG. 5 is a high-level block diagram of a runtime environment 501 for implementing a method and system for real-time automated identification of fraudulent invoices in accordance with one embodiment. As noted above, trained machine learning-based fraudulent invoice detection model 171 is deployed in runtime environment 501 to generate fraudulent invoice scores for subsequent, or new, invoices before those invoices are paid by, and in some cases before the invoices are provided to, the parties being asked to pay the invoices, i.e., the potential payors associated with the invoices.

Shown in FIG. 5 is runtime environment 501 including data management system 511, FIG. 5, merchant computing environment 531, including merchant computing system 533, and user computing environment 591 including user computing system 593. Runtime environment 501, merchant computing environment 531, and user computing system 593 are operational coupled using one or more communication channels 599.

As seen in FIG. 5, runtime environment 501 includes data management system 511. In this specific illustrative example, data management system 511 can be, but is not limited to, a small business data management system, a personal financial data management system, a transaction data management system, and the like.

In this specific illustrative example, data management system 511 offers merchant/payee users of the data management system 511 the capability to generate and/or submit invoices to customer/payor users of the data management system 511. The merchant/payee users can submit invoices to the customer/payor users by submitting invoice data, such as subsequent invoice data 513, using merchant computing systems, such as merchant computing system 533 in merchant computing environment 531, to data management system 511. Then, as discussed below, if determined to be non-fraudulent, or legitimate, the invoices represented by subsequent invoice data 513 are provided to customer/payor users of the data management system 511. If determined to be legitimate, the invoices represented by subsequent invoice data 513 are provided to the to customer/payor users of the data management system 511 through user interface module 570 which provides legitimate invoices represented by subsequent invoice data 513 to user computing system 593 in user computing environment 591. In addition, in this specific illustrative example, data management system 511 offers the customer/payor users the capability to pay invoices through the data management system 511.

In an effort to decrease the opportunities for fraud associated with the offered invoice and invoice payment services, in this specific illustrative example, data management system 511 includes fraudulent invoice identification and processing system 512 implementing a method and system for real-time automated identification of fraudulent invoices.

As seen in FIG. 5, fraudulent invoice identification and processing system 512 includes invoice text identification and extraction module 121, invoice feature extraction module 150, and trained machine learning-based fraudulent invoice detection model 171, all of which are discussed above with respect to FIG. 1. In addition, fraudulent invoice identification and processing system 512 includes compare module 577, pass subsequent invoice data to user module 581, alert analyst/user module 583, and block payment to merchant/add merchant to fraudulent merchant list module 585.

As noted, data management system 511 offers merchant/payee users of the data management system 511 the capability to generate and/or submit invoices represented in FIG. 5 by subsequent invoice data 513.

As discussed above, FIG. 3 as an example of an invoice, in the particular example of FIG. 3 a fraudulent invoice, that is illustrative of the types of invoices, both fraudulent and legitimate, represented by subsequent invoice data 513.

In some cases, the invoice represented by subsequent invoice data 513 is generated outside of the data management system 511 and is either submitted by a merchant user of the data management system 511 via merchant computing system 533 or are uploaded by customer or payor user of the data management system 11 via user computing system 593.

As seen in FIG. 5, once received from merchant computing system 533, subsequent invoice data 513 is provided to invoice text identification and extraction module 121. Invoice text identification and extraction module 121 is discussed above with respect to FIG. 1 and is identically implemented in FIG. 5 to process subsequent invoice data 513 as discussed above.

Therefore, at invoice text identification and extraction module 121 one or more methods are used to identify and extract invoice text data 522 associated with subsequent invoice data 513. Invoice text data 522 is similar to invoice text data 122 discussed above with respect to FIG. 1.

Returning to FIG. 5, in one example, OCR techniques are used to identify and extract the invoice text data 522 associated with subsequent invoice data 513. As noted above, various OCR systems and techniques are well known to those of skill in the art. Consequently, a more detailed description of the operation of any specific OCR technique used to identify and extract invoice text data 522 associated with subsequent invoice data 513 is omitted here to avoid detracting from the invention.

Once invoice text data 522 associated to subsequent invoice data 513 is identified and extracted, the invoice text data 522 is provided to invoice feature extraction module 150. Invoice feature extraction module 150 of FIG. 5 is identical to invoice feature extraction module 150 of FIG. 1 and operates in an identical manner.

Consequently, at invoice feature extraction module 150, the invoice text data 522 is further processed to identify and extract one or more invoice features associated with the invoice represented by subsequent invoice data 513. The collection of these invoice features associated with the invoice represented by subsequent invoice data 513 is represented in FIG. 5 by subsequent invoice feature data 551.

As discussed in more detail above, the invoice features can be pre-defined, or pre-identified, as features, or data elements, associated with invoices that, depending on the present, absence, or state, of the features can be indicative of fraud or legitimacy of a given invoice. In some cases, the invoice features are defined by analysis of historically known fraudulent invoices and the elements of those invoices that were found to be indicative, or not indicative, of fraudulent invoices. In some cases, the invoice features are defined by analysis performed by human analysts. In other cases, the invoice features are defined and identified by virtue of the processing of historical invoice data 113 of FIG. 1 by one or more processing modules including, but not limited to one or more machine learning-based models. In some cases, the invoice features are defined and identified by machine learning-based fraudulent invoice detection models, such as trained machine learning-based fraudulent invoice detection model 171.

Once defined, data representing the invoice features is collected as defined feature data 130. FIG. 2 is an illustrative example of an invoice feature list 200 that could be included in defined feature data 130 of FIG. 1. It must be noted again that the invoice feature list 200 of FIG. 2 includes a mere sampling of the number and type of invoice features that can be defined, identified, and extracted according to the disclosed embodiments. In particular, the number and type of invoice features shown in invoice feature list 200 is by no means exhaustive nor limiting with respect to the number and type of invoice features contemplated by the inventors.

Returning to FIG. 5, in order for invoice feature extraction module 150 to identify the features present in the invoice represented by subsequent invoice data 513, it is important that invoice text data 522 be processed by one or more methods to indicate not only that the invoice feature is present, but also the location of the invoice feature data in the invoice data. As discussed in more detail above with respect to FIG. 1, in one example, this is accomplished by using a combination of OCR techniques JSON file formatting.

As seen in FIG. 5, once the invoice features are identified and extracted for the invoice represented by subsequent invoice data 513, and subsequent invoice feature data 551 is generated, subsequent invoice feature data 551 is formatted in a manner similar to that discussed above with respect to FIG. 4, and is then provided to trained machine learning-based fraudulent invoice detection model 171. As discussed below, trained machine learning-based fraudulent invoice detection model 171 is then used to generate a fraudulent invoice score, represented by subsequent invoice fraud score data 573 in FIG. 5, for the invoice represented by subsequent invoice data 513. Subsequent invoice fraud score data 573 indicates a determined probability that the invoice represented by subsequent invoice data 513 is fraudulent.

Once subsequent invoice fraud score data 573 for the invoice represented by subsequent invoice data 513 is generated, the fraudulent invoice score represented by subsequent invoice fraud score data 573 is provided to compare module 577.

At compare module 577 the fraudulent invoice score represented by subsequent invoice fraud score data 573 is compared with one or more threshold fraudulent invoice scores, represented by threshold invoice fraud score data 575 in FIG. 5. The one or more threshold fraudulent invoice scores represented by threshold invoice fraud score data 575 can be associated with one or more respective protective actions to be taken.

For instance, if the fraudulent invoice score represented by subsequent invoice fraud score data 573 is less than a first, or low, threshold fraudulent invoice score represented in threshold invoice fraud score data 575, then the invoice represented by subsequent invoice data 513 is processed by pass subsequent invoice data to the user module 581. At pass subsequent invoice data to the user module 581, the invoice represented by subsequent invoice data 513 is passed through user interface module 570 to user computing environment 591 and user computing system 593 via communication channel 599 and to the indicated payor associated with user computing system 593. The payor is then allowed to pay the invoice without further analysis.

However, if the fraudulent invoice score represented by subsequent invoice fraud score data 573 is greater than a second, or high, threshold fraudulent invoice score represented in threshold invoice fraud score data 575, the invoice represented by subsequent invoice data 513 is processed by block payment to merchant/add merchant to fraudulent merchant list module 585.

At block payment to merchant/add merchant to fraudulent merchant list module 585, one or more of the following protective actions are taken: the merchant associated with the invoice represented by subsequent invoice data 513 is added to feedback/improvement data 191 and then to the known fraudulent merchant list of the fraudulent merchant data 114 of FIG. 1; the invoice represented by subsequent invoice data 513 is blocked from user computing system 593, and the payor is not allowed to pay the invoice represented by subsequent invoice data 513; all future invoices from the now identified fraudulent merchant of the invoice represented by subsequent invoice data 513 are blocked; and all future attempted payments to the now identified fraudulent merchant of the invoice represented by subsequent invoice data 513 are blocked. In addition, as discussed below, the subsequent invoice feature data 551 associated with subsequent invoice data 513, and other information about the invoice represented by subsequent invoice data 513, is collected in feedback/improvement data 191 and sent to model training environment 101 of FIG. 1 for use by model training module 170.

In some cases, fraudulent invoice score represented by subsequent invoice fraud score data 573 is between the first, or low, threshold fraudulent invoice score and the second, or high, threshold fraudulent invoice score of threshold invoice fraud score data 575. In these cases, the invoice represented by subsequent invoice data 513 is processed by alert analyst/user module 583.

At alert analyst/user module 583 an alert (not shown) can be generated and provided to a fraudulent invoice analyst and/or the indicated payor indicating that the invoice represented by subsequent invoice data 513 is potentially fraudulent and requesting the analyst and/payor make sure that the invoice is legitimate before making any payment associated with the invoice.

As seen in FIG. 5, the results of each of the processing modules 581, 583, and 585, along with relevant portions of the subsequent invoice feature data 551, and other data associated with subsequent invoices, such as the invoice represented by subsequent invoice data 513, is collected as feedback/improvement data 191 and then provided to model training environment 101 of FIG. 1.

At model training environment 101 of FIG. 1, portions of feedback/improvement data 191 are provided to fraudulent merchant data 114 to update the list of fraudulent merchants in fraudulent merchant data 114, and to model training module 170.

At model training module 170 feedback/improvement data 191, including newly defined or identified fraudulent invoice feature data 161 and fraudulent invoice determination labels, is used periodically re-train and iteratively update and improve trained machine learning-based fraudulent invoice detection model 171.

Consequently, trained machine learning-based fraudulent invoice detection model 171 and the fraudulent invoice identification methods and systems disclosed herein can dynamically react to new techniques used by fraudsters and new fraudulent invoice data.

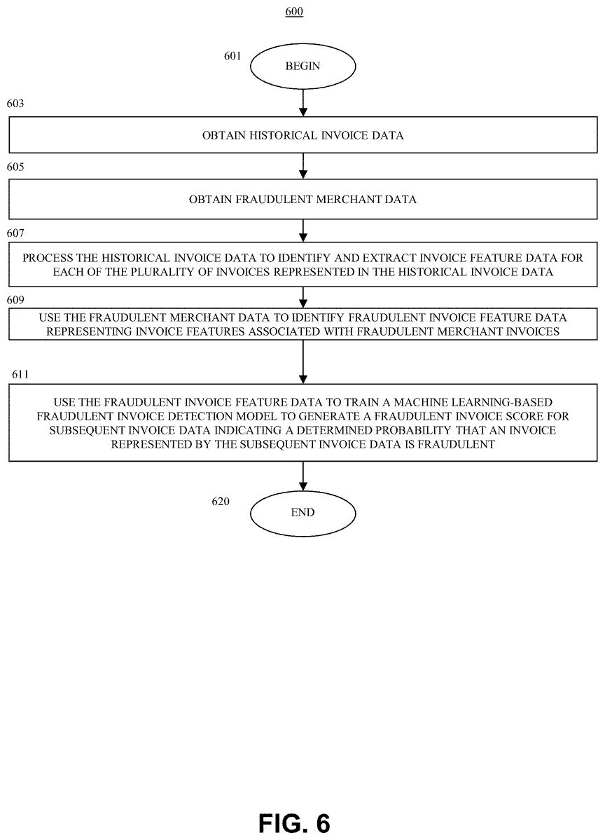

FIG. 6 is a flow chart representing a process 600 for training a machine learning-based fraudulent invoice detection model in accordance with one embodiment.

Referring to FIGS. 1 through 5 and 6, process 600 begins at operation 601 and process flow proceeds to operation 603.

At operation 603 historical invoice data representing a plurality of invoices submitted by merchants, such as any of the historical invoice data discussed herein with respect to FIGS. 1 and 2, is obtained using any of the methods discussed above with respect to FIG. 1.

Once historical invoice data representing a plurality of invoices submitted by merchants is obtained at operation 603, process flow proceeds to operation 605.

At operation 605, fraudulent merchant data representing a listing of known fraudulent merchants, such any of the fraudulent merchant data discussed herein with respect to FIG. 1, is obtained using any of the methods discussed herein with respect to FIG. 1.

Once fraudulent merchant data representing a listing of known fraudulent merchants is obtained at operation 605, process flow proceeds to operation 607.

At operation 607, the historical invoice data of operation 605 is processed using any of the methods discussed herein with respect to FIGS. 1, 2, and 3 to identify and extract invoice feature data representing one or more invoice features for each of the plurality of invoices represented in the historical invoice data. The one or more invoice features for each of the plurality of invoices represented in the historical invoice data can be any of the invoice features discussed herein with respect to FIGS. 1, 2, and 3, and/or as known in the art at the time of filing, or as become known after the time of filing.

Once invoice feature data is identified and extracted for each of the plurality of invoices represented in the historical invoice data at operation 607, process flow proceeds to operation 609.

At operation 609, the fraudulent merchant data of operation 603 is used to identify fraudulent invoice feature data representing invoice features associated with fraudulent merchant invoices using any of the methods discussed above with respect to FIG. 1.

Once the fraudulent merchant data is used to identify fraudulent invoice feature data representing invoice features associated with fraudulent merchant invoices at operation 609, process flow proceeds to operation 611.

At operation 611, the fraudulent invoice feature data of operation 609 is used to train a machine learning-based fraudulent invoice detection model, using any of the methods discussed herein with respect to FIGS. 1 and 4, to generate a fraudulent invoice score for subsequent invoice data. The fraudulent invoice score can indicate a determined probability that an invoice represented by the subsequent invoice data is fraudulent.

Once the fraudulent invoice feature data is used to train a machine learning-based fraudulent invoice detection model at operation 611, process flow proceeds to end operation 620. At end operation 620, process 600 is exited to await new data.

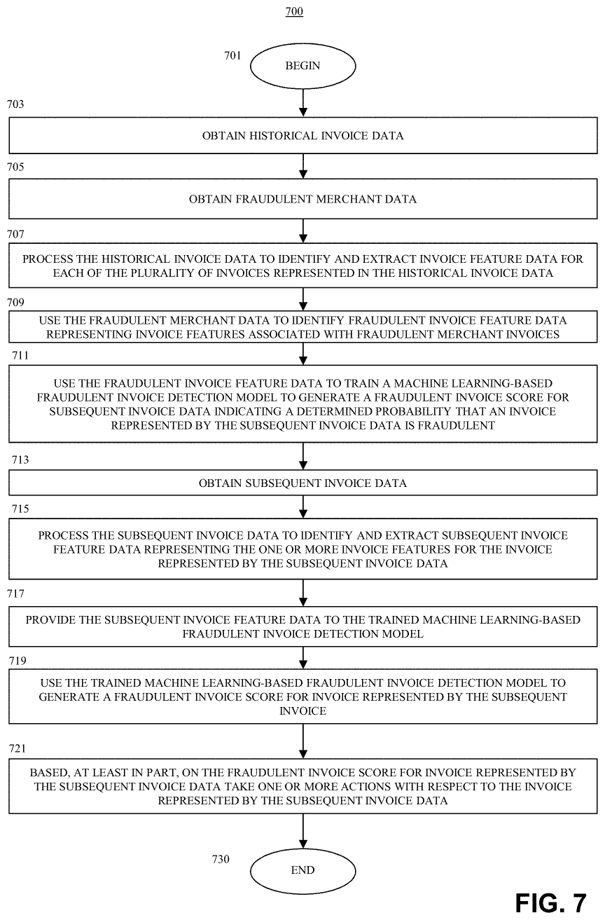

FIG. 7 is a flow chart representing a process for real-time automated identification of fraudulent invoices in accordance with one embodiment.

Referring to FIGS. 1 through 6, and 7, process 700 begins at operation 701 and process flow proceeds to operation 703.

At operation 703 historical invoice data representing a plurality of invoices submitted by merchants, such as any of the historical invoice data discussed herein with respect to FIGS. 1 and 2, is obtained using any of the methods discussed above with respect to FIG. 1.

Once historical invoice data representing a plurality of invoices submitted by merchants is obtained at operation 703, process flow proceeds to operation 705.

At operation 705, fraudulent merchant data representing a listing of known fraudulent merchants, such any of the fraudulent merchant data discussed herein with respect to FIG. 1, is obtained using any of the methods discussed herein with respect to FIG. 1.

Once fraudulent merchant data representing a listing of known fraudulent merchants is obtained at operation 705, process flow proceeds to operation 707.

At operation 707, the historical invoice data of operation 705 is processed using any of the methods discussed herein with respect to FIGS. 1, 2, and 3 to identify and extract invoice feature data representing one or more invoice features for each of the plurality of invoices represented in the historical invoice data. The one or more invoice features for each of the plurality of invoices represented in the historical invoice data can be any of the invoice features discussed herein with respect to FIGS. 1, 2, and 3, and/or as known in the art at the time of filing, or as become known after the time of filing.

Once invoice feature data is identified and extracted for each of the plurality of invoices represented in the historical invoice data at operation 707, process flow proceeds to operation 709.

At operation 709, the fraudulent merchant data of operation 703 is used to identify fraudulent invoice feature data representing invoice features associated with fraudulent merchant invoices using any of the methods discussed above with respect to FIG. 1.

Once the fraudulent merchant data is used to identify fraudulent invoice feature data representing invoice features associated with fraudulent merchant invoices at operation 709, process flow proceeds to operation 711.

At operation 711, the fraudulent invoice feature data of operation 709 is used to train a machine learning-based fraudulent invoice detection model, using any of the methods discussed herein with respect to FIGS. 1 and 4, to generate a fraudulent invoice score for subsequent invoice data. The fraudulent invoice score can indicate a determined probability that an invoice represented by the subsequent invoice data is fraudulent.

Once the fraudulent invoice feature data is used to train a machine learning-based fraudulent invoice detection model at operation 711, process flow proceeds to operation 713.

At operation 713 subsequent invoice data is obtained representing an invoice obtained after the machine learning-based fraudulent invoice detection model has been trained at operation 711 using any of the methods discussed herein with respect to FIG. 5.

Once subsequent invoice data is obtained at operation 713, process flow proceeds to operation 715.

At operation 715, the subsequent invoice data of operation 713 is processed to identify and extract subsequent invoice feature data representing the one or more invoice features for the invoice represented by the subsequent invoice data using any of the methods discussed herein with respect to FIGS. 2, 3, 4, and 5.

Once subsequent invoice data is processed to identify and extract subsequent invoice feature data at 715, process flow proceeds to operation 717.

At operation 717 the subsequent invoice feature data of operation 715 is provided to the trained machine learning-based fraudulent invoice detection model of operation 711.

Once the subsequent invoice feature data is provided to the trained machine learning-based fraudulent invoice detection model at operation 717, process flow proceeds to operation 719.

At operation 719, the trained machine learning-based fraudulent invoice detection model of operation 711 processes the subsequent invoice feature data of operation 715 to generate a fraudulent invoice score for invoice represented by the subsequent invoice data of operation 713. The fraudulent invoice score can indicate a determined probability that invoice represented by the subsequent invoice data of operation 713 is fraudulent using any of the methods discussed herein with respect to FIGS. 2, 3, 4, and 5.

Once the trained machine learning-based fraudulent invoice detection model processes the subsequent invoice feature data to generate a fraudulent invoice score for invoice represented by the subsequent invoice data at operation 719, process flow proceeds to operation 721.

At operation 721, based, at least in part, on the fraudulent invoice score for invoice represented by the subsequent invoice data of operation 719, one or more actions are taken with respect to the invoice represented by the subsequent invoice data of operation 713. The actions taken can include any of the actions discussed herein with respect to FIG. 5.

Once based, at least in part, on the fraudulent invoice score for invoice represented by the subsequent invoice data, one or more actions are taken with respect to the invoice represented by the subsequent invoice data operation 721, process flow proceeds to end operation 730. At end operation 730, process 700 is exited to await new data.

In the discussion above, certain aspects of one embodiment include process steps and/or operations and/or instructions described herein for illustrative purposes in a specific order and/or grouping. However, the specific order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the specific order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various users under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

In addition, the operations shown in the FIGs., or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method comprising:
obtaining historical invoice data representing a plurality of invoices submitted by merchants;
obtaining fraudulent merchant data representing a listing of known fraudulent merchants;
processing the historical invoice data to identify and extract invoice feature data representing one or more invoice features for each of the plurality of invoices represented in the historical invoice data;
processing the fraudulent merchant data and extracted invoice feature data to identify fraudulent invoice feature data representing invoice features associated with fraudulent merchant invoices; and
using the fraudulent invoice feature data to train a machine learning-based fraudulent invoice detection model to generate a fraudulent invoice score for subsequent invoice data indicating a determined probability that an invoice represented by the subsequent invoice data is fraudulent.

2. The computing system implemented method of claim 1 wherein at least part of the fraudulent merchant data representing a listing of known fraudulent merchants is obtained from human analysis of historical invoices and the identification of fraudulent merchants by the human analysis;

3. The computing system implemented method of claim 1 wherein processing the historical invoice data to identify and extract invoice feature data representing one or more invoice features for each of the plurality of invoices represented in the historical invoice data further comprises:
processing the historical invoice data using an Optical Character Recognition (OCR) system to identify and extract text data from each of the plurality of invoices represented in the historical invoice data; and
processing the extracted text data from each of the plurality of invoices represented in the historical invoice data using JavaScript Object Notation (JSON) to identify the location of the invoice feature data in the extracted text data from each of the plurality of invoices represented in the historical invoice data.

4. The computing system implemented method of claim 1 wherein the one or more invoice features are selected from the group of invoice features including:
a file suffix feature;
a logo present feature;
an item quantity feature;
a company website present feature;
a company or payee address present feature;
a payor address present feature;
a taxes present feature;
an invoice number length feature;
a recurring digits in invoice number feature;
an amounts ending in .99 feature;
a company name list match feature;
a grammatical errors present feature;
a spelling errors present feature; and
a formatting errors present feature.

5. The computing system implemented method of claim 4 wherein one or more of the invoice features are identified and processed using Natural Language Processing (NLP) techniques.

6. The computing system implemented method of claim 1 wherein the machine learning-based fraudulent invoice detection model is a supervised machine learning-based fraudulent invoice detection model.

7. The computing system implemented method of claim 1 wherein the machine learning-based fraudulent invoice detection model is an unsupervised machine learning-based fraudulent invoice detection model.

8. The computing system implemented method of claim 1 further comprising:
obtaining subsequent invoice data representing an invoice obtained after the machine learning-based fraudulent invoice detection model has been trained;
processing the subsequent invoice data to identify and extract subsequent invoice feature data representing the one or more invoice features for the invoice represented by the subsequent invoice data;
providing the subsequent invoice feature data to the trained machine learning-based fraudulent invoice detection model;
using the trained machine learning-based fraudulent invoice detection model to generate a fraudulent invoice score for the invoice represented by the subsequent invoice data, the fraudulent invoice score indicating a determined probability that invoice represented by the subsequent invoice data is fraudulent; and
based, at least in part, on the fraudulent invoice score for invoice represented by the subsequent invoice data, taking one or more actions with respect to the invoice represented by the subsequent invoice data.

9. The computing system implemented method of claim 8 wherein the one or more actions taken with respect to the invoice represented by the subsequent invoice data includes one or more of:
allowing the invoice represented by the subsequent invoice data to be passed to a payor indicated in the subsequent invoice data;
allowing the invoice represented by the subsequent invoice data to be paid by a payor indicated in the subsequent invoice data;
sending the invoice represented by the subsequent invoice data to an invoice fraud specialist for analysis before passing the invoice represented by the subsequent invoice data to a payor indicated in the subsequent invoice data;
sending the invoice represented by the subsequent invoice data to an invoice fraud specialist for analysis before allowing the invoice represented by the subsequent invoice data to be paid;
alerting a payor indicated in the subsequent invoice data that the invoice represented by the subsequent invoice data may be fraudulent;
blocking payment of the invoice;
adding merchant data representing a merchant associated with the invoice represented by the subsequent invoice data to the fraudulent merchant data; and
blocking all future attempted payments to the merchant associated with the invoice represented by the subsequent invoice data.

10. The computing system implemented method of claim 9 wherein after adding the merchant data representing a merchant associated with the invoice represented by the subsequent invoice data to the fraudulent merchant data, the updated fraudulent merchant data is used to re-train and improve the machine learning-based fraudulent invoice detection model.

11. A computing system implemented method comprising:
providing, with the one or more computing systems, a data management system;
obtaining historical invoice data representing a plurality of invoices submitted by merchants through the data management system;
obtaining fraudulent merchant data representing a listing of known fraudulent merchants identified by human analysis of historical invoices submitted by fraudulent merchants;
processing the historical invoice data to identify and extract invoice feature data representing one or more invoice features for each of the plurality of invoices represented in the historical invoice data;
processing the fraudulent merchant data and extracted invoice feature data to identify fraudulent invoice feature data representing invoice features associated with fraudulent merchant invoices;
using the fraudulent invoice feature data to train a machine learning-based fraudulent invoice detection model to generate a fraudulent invoice score for subsequent invoice data, the fraudulent invoice score indicating a determined probability that an invoice represented by the subsequent invoice data is fraudulent;
obtaining subsequent invoice data representing an invoice submitted by a merchant through the data management system;
processing the subsequent invoice data to identify and extract subsequent invoice feature data representing the one or more invoice features for the invoice represented by the subsequent invoice data;
providing the subsequent invoice feature data to the trained machine learning-based fraudulent invoice detection model;
using the trained machine learning-based fraudulent invoice detection model to generate a fraudulent invoice score for the invoice represented by the subsequent invoice data, the fraudulent invoice score indicating a determined probability that invoice represented by the subsequent invoice data is fraudulent; and
based, at least in part, on the fraudulent invoice score for invoice represented by the subsequent invoice data, taking one or more actions with respect to the invoice represented by the subsequent invoice data.

12. The computing system implemented method of claim 11 wherein processing the historical or subsequent invoice data to identify and extract invoice feature data representing one or more invoice features for each of the invoices represented in the invoice data further comprises:
processing the invoice data using an Optical Character Recognition (OCR) system to identify and extract text data from each of the invoices represented in the invoice data; and
processing the extracted text data from each of the invoices represented in the invoice data using JavaScript Object Notation (JSON) to identify the location of the invoice feature data in the extracted text data from each of the invoices represented in the invoice data.

13. The computing system implemented method of claim 11 wherein the one or more invoice features are selected from the group of invoice features including:
a file suffix feature;
a logo present feature;
an item quantity feature;
a company website present feature;
a company or payee address present feature;
a payor address present feature;
a taxes present feature;
an invoice number length feature;
a recurring digits in invoice number feature;
an amounts ending in .99 feature;
a company name list match feature;
a grammatical errors present feature;
a spelling errors present feature; and
a formatting errors present feature.

14. The computing system implemented method of claim 13 wherein one or more of the invoice features are identified and processed using Natural Language Processing (NLP) techniques.

15. The computing system implemented method of claim 11 wherein the one or more actions taken with respect to the invoice represented by the subsequent invoice data includes one or more of:
allowing the invoice represented by the subsequent invoice data to be passed to a payor indicated in the subsequent invoice data;
allowing the invoice represented by the subsequent invoice data to be paid by a payor indicated in the subsequent invoice data;
sending the invoice represented by the subsequent invoice data to an invoice fraud specialist for analysis before passing the invoice represented by the subsequent invoice data to a payor indicated in the subsequent invoice data;
sending the invoice represented by the subsequent invoice data to an invoice fraud specialist for analysis before allowing the invoice represented by the subsequent invoice data to be paid;
alerting a payor indicated in the subsequent invoice data that the invoice represented by the subsequent invoice data may be fraudulent;
blocking payment of the invoice;
adding merchant data representing a merchant associated with the invoice represented by the subsequent invoice data to the fraudulent merchant data; and
blocking all future attempted payments to the merchant associated with the invoice represented by the subsequent invoice data.

16. The computing system implemented method of claim 15 wherein after adding the merchant data representing a merchant associated with the invoice represented by the subsequent invoice data to the fraudulent merchant data, the updated fraudulent merchant data is used to re-train and improve the machine learning-based fraudulent invoice detection model.

17. A system comprising:
at least one processor; and
at least one memory coupled to the at least one processor, the at least one memory having stored therein instructions which, when executed by any set of the one or more processors, perform a process including:
obtaining historical invoice data representing a plurality of invoices submitted by merchants;
obtaining fraudulent merchant data representing a listing of known fraudulent merchants identified by human analysis of historical invoices submitted by fraudulent merchants;
processing the historical invoice data to identify and extract invoice feature data representing one or more invoice features for each of the plurality of invoices represented in the historical invoice data;
processing the fraudulent merchant data and extracted invoice feature data to identify fraudulent invoice feature data representing invoice features associated with fraudulent merchant invoices;
using the fraudulent invoice feature data to train a machine learning-based fraudulent invoice detection model to generate a fraudulent invoice score for subsequent invoice data, the fraudulent invoice score indicating a determined probability that an invoice represented by the subsequent invoice data is fraudulent;
obtaining subsequent invoice data representing an invoice submitted by a merchant;
processing the subsequent invoice data to identify and extract subsequent invoice feature data representing the one or more invoice features for the invoice represented by the subsequent invoice data;
providing the subsequent invoice feature data to the trained machine learning-based fraudulent invoice detection model;
using the trained machine learning-based fraudulent invoice detection model to generate a fraudulent invoice score for the invoice represented by the subsequent invoice data, the fraudulent invoice score indicating a determined probability that invoice represented by the subsequent invoice data is fraudulent; and
based, at least in part, on the fraudulent invoice score for invoice represented by the subsequent invoice data, taking one or more actions with respect to the invoice represented by the subsequent invoice data.

18. The system of claim 17 wherein processing the historical or subsequent invoice data to identify and extract invoice feature data representing one or more invoice features for each of the invoices represented in the invoice data further comprises:
processing the invoice data using an Optical Character Recognition (OCR) system to identify and extract text data from each of the invoices represented in the invoice data; and
processing the extracted text data from each of the invoices represented in the invoice data using JavaScript Object Notation (JSON) to identify the location of the invoice feature data in the extracted text data from each of the invoices represented in the invoice data.

19. The system of claim 17 wherein the one or more invoice features are selected from the group of invoice features including:
a file suffix feature;
a logo present feature;
an item quantity feature;
a company website present feature;
a company or payee address present feature;
a payor address present feature;
a taxes present feature;
an invoice number length feature;
a recurring digits in invoice number feature;
an amounts ending in .99 feature;
a company name list match feature;
a grammatical errors present feature;
a spelling errors present feature; and
a formatting errors present feature.

20. The system of claim 17 wherein the one or more actions taken with respect to the invoice represented by the subsequent invoice data includes one or more of:
allowing the invoice represented by the subsequent invoice data to be passed to a payor indicated in the subsequent invoice data;
allowing the invoice represented by the subsequent invoice data to be paid by a payor indicated in the subsequent invoice data;
sending the invoice represented by the subsequent invoice data to an invoice fraud specialist for analysis before passing the invoice represented by the subsequent invoice data to a payor indicated in the subsequent invoice data;
sending the invoice represented by the subsequent invoice data to an invoice fraud specialist for analysis before allowing the invoice represented by the subsequent invoice data to be paid;
alerting a payor indicated in the subsequent invoice data that the invoice represented by the subsequent invoice data may be fraudulent;
blocking payment of the invoice;
adding merchant data representing a merchant associated with the invoice represented by the subsequent invoice data to the fraudulent merchant data; and
blocking all future attempted payments to the merchant associated with the invoice represented by the subsequent invoice data.
